(19) United States
(12) Patent Application Publication
(10) Pub. No.: US 2005/0248780 A1
(43) Pub. Date: Nov. 10, 2005

(54) Digital printing highlights and image processing workflow

(76) Inventors: Michael J. Piatt, Dayton, OH (US); Jennifer L. Addis, Columbus, OH (US); Joshua H. Howard, Kettering, OH (US); Terry A. Wozniak, Springfield, OH (US)

Correspondence Address: Mark G. Bocchetti;Patent Legal Staff, Eastman Kodak Company, 343 State Street, Rochester, NY, 14650-2201, US

(21) Appl. No.: 10/839,465

(22) Filed: May 5, 2004

(51) Int. Cl. G06K 15/02; H04N 1/405; H04N 1/56; H04N 1/60; H04N 1/52; H04N 1/58; H04N 1/407; H04N 1/409

(52) U.S. Cl. 358/1.9; 358/3.26; 358/3.23; 358/3.22; 358/3.27; 358/3.02; 358/3.06; 358/3.13

(57) ABSTRACT

The methods for processing an image from data for imaging on a digital output device include inputting data made of numerous image pixels with values representative of the pixel intensity for imaging to a digital output device, employing a threshold highlight value into the digital output device, and applying data transformation to the data for imaging using the threshold highlight value to form transformed data. The methods end by forming a representation from the transformed data. The representation is a value representative of the pixel intensity greater than or equal to 1.

### FIELD OF THE INVENTION

The present embodiments relate to methods for the image processing of digital data for output to a printing device.

### BACKGROUND OF THE INVENTION

Traditional offset printing systems modulate dot size in order to create a full tone scale from light to dark. The minimum dot size is used in the highlight areas and is below the level of human perception, making the image look continuous. Digital printing systems, such as continuous and drop-on-demand inkjet systems, typically use a single size droplet to create the entire tone scale. The sporadic frequency of droplets on the substrate determines the tone. Algorithms, such as error diffusion and dither matrices, are used as a part of the imaging processing to transform continuous tone data into spatially distributed dot patters to represent the image data of the original file.

Some digital printing devices have an individual dot size below the threshold of human perception. For these systems, special treatment is not necessary to eliminate digital artifacts because the resulting printed image looks continuous to human eye. Other lower resolution printing devices have a fixed dot size that is easily detected by the human eye. Image artifacts are a common problem for these devices. The printed output looks digital in nature in the highlight areas were the droplet population per unit area is low. Various droplet dispersion algorithms strive to minimize these effects by randomizing the print locations of individual droplets. In spite of these techniques, the image quality is compromised by objectionable individual dots that are clearly visible in the highlight areas.

A need exists for a method to eliminate these dots all together to improve image quality.

In addition, International Color Consortium (ICC) profiles are typically used to transform the data and maintain color fidelity in printing color pages. One dimensional input-output transforms eliminate the very low end of the tonal scale data of each of the color planes independently. The resulting full processed color pixel is minimally affected by this process because of the preferential order of operations. However, performing similar transforms prior to color management only serves to compound the error, and still requires further treatment of the highlight areas after the image has been color managed. The drawback to a color-managed workflow is the complexity of the method. A need exists for a more simple system for color management.

In many cases, single primary colors (Cyan, Magenta, Yellow, Black), which go through a color-managed workflow, do not come out as single colors. These primary colors usually have a secondary color added to them in order to match the source color. This results in low quality prints on an inkjet printer. Known as “scum dots”, these low quality areas would have to be manually taken out of each page. A need has existed to manage scum dots and minimize their effect.

Pure colors are not the only problem; any low tone color that goes through the multidimensional transform may output as very low tone percentages of certain primary inks. These colors, in turn, will be sporadically placed as visible dots on the substrate after further processing, using droplet dispersion algorithms to convert the digital tone values onto binary droplet locations.

Not all inks are equally perceptible; black droplets on white paper are much more objectionable than a few yellow dots that are almost imperceptible. Since all inks are not equally perceptible, each ink is treated independently with a one dimensional transform after color management and prior to dithering. A need exists for a means for automatically eliminating low spatial frequency dots, or “scum dots”, using user supplied input values.

The embodied methods herein are designed to meet these needs.

### SUMMARY OF THE INVENTION

The method for processing an image from data for imaging on a digital output device entails inputting data for imaging to a digital output device and employing a threshold highlight value into the digital output device. The data for imaging is numerous image pixels values representative of the pixel intensity. The method continues by applying data transformation to the data for imaging using the threshold highlight value to form transformed data. A representation is formed from the transformed data. The representation is a value representative of the pixel intensity greater than or equal to 1.

### BRIEF DESCRIPTION OF THE DRAWINGS

In the detailed description of the preferred embodiments presented below, reference is made to the accompanying drawings, in which:

FIG. 1 is a block diagram depicting the work flow based upon the embodied methods.

FIG. 2 provides an example of a one dimensional transformation within the scope of this method.

FIG. 3a provides an example of contamination of a visual image that this process avoids.

FIG. 3b provides an example of image graininess of a visual image that this process avoids FIG. 3c provides an example of discernable individual undesirable dots sought to be avoided using the embodied methods.

FIG. 4 depicts the slider and the edit box used to input the highlight threshold value used in the embodied methods.

FIG. 5a depicts a representation.

FIG. 5b depicts a representation.

FIG. 6a provides example of a vector based image.

FIG. 6b provides example of a continuous tone image.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways.

The methods herein pertain to digital-imaging systems with individual dot sizes that are large enough to be easily seen with the human eye. The methods are used to improve image quality of digital printing systems.

Often in ink jet printing, data that is input to a digital output device produces visual artifacts as well as the more desirable image pixels when using the more traditional data transformation tools, such as ICC, or linearization tables. Accordingly, the embodied methods were created so that a user can automatically set a threshold value to eliminate the undesirable visual artifacts, and produce a higher quality image that is faster and more effortless than currently available processes.

One feature of one embodiment of the method is involves a user inputting the highlighted threshold value and then processing the image in microseconds to eliminate undesirable artifacts. Traditionally, undesirable artifacts have had to be removed by hand, which can take several minutes, plus the imaging process must be re-ripped. These time-consuming processes are replaced by the fast, less expensive method embodied herein.

Dots in the highlight areas of an image are eliminated in order to improve the over-all appearance of the image using these methods. The elimination of highlight artifacts is now automated through the use of one-dimensional transfer functions. The one-dimensional transfer functions act on data pre-processed through a color management module. With this one dimension transfer function, the color fidelity of the image, derived through color management operations, can be maintained.

The embodied methods are sequences of steps for automatic data preparation in a printing system that eliminates individual dot artifacts in the highlight areas. The methods pertain to an automatic elimination of low spatial frequency dots that may be subsequently generated through image processing. The user inputs color initiation percentage values, as a percent of full scale, for each primary color independently.

The methods for processing an image from data for imaging on a digital output device entail inputting data for imaging to a digital output device. The data for imaging is numerous image pixels values representative of the pixel intensity. A threshold highlight value is added into the digital output device and a data transformation is applied to the data for imaging using the threshold highlight value to form transformed data. The methods end by forming a representation from the transformed data. The representation is a value representative of the pixel intensity greater than or equal to one.

These methods act upon data after being transformed using International Color Consortium (ICC) profiles to maintain color fidelity and prior to binary digitization of the image data.

Highlight thresholds are individually selected by user for each ink in the system (CMYK) and for different workflows (CMYK, RGB, L*a*b*) and are based upon a particular output device (single drop or multi-drop).

Selected parameters are universally applied to all images passing through digital front-end, and may be applied selectively based upon type of image data. For example, text and line art can be handled differently that graphics.

Parameters of transformation usable in this method can be varied based upon selected output dithering, stochastic screen, or error diffusion, as examples.

Algorithms can be extended beyond one-dimensional transformations, to two dimensions, three dimension, four dimensional or more and even up to eight dimensions. Four-dimensional data transformation can be more robust than four single one-dimensional transforms because the four-dimensional data transformation considers all four inputs simultaneously to determine the four new outputs. Four single one-dimensional transformations each consider only one input at a time, and select an output based solely on the limited information

Algorithms can be extended so transformations are only applied if a number of adjacent pixels are all below a specified threshold. For example, a single highlight pixel can be printed and a particular region of highlight area can be excluded from print.

Selection of data transformations can be built into the front end of the method to be a function of printable substrate. Selection of data transformations can be a function of dot gain that is known to be linked to speed and type of print media. More specifically, data transformations can use print speed and print media threshold dependent values.

Different data transformations can be applied using a look up table, which applies a one to one ratio.

The methods provide for the automatic elimination of low spatial frequency dots given user input for the percentage at which colors may be introduced in a highlight region. Since RGB and L*a*b* data are both three-dimensional color spaces, RGB and L*a*b* data undergo similar transformations. The user only needs to enter in one set of inputs for both the RGB and L*a*b* input spaces. Since black ink reacts much differently when introduced in highlight regions than other colors, specifically Cyan, Magenta, and Yellow, the user is able to input a separate value for the introduction of Black data than of other colors. Image processing of input CMYK image can require different one-dimensional transforms in order to optimize image quality.

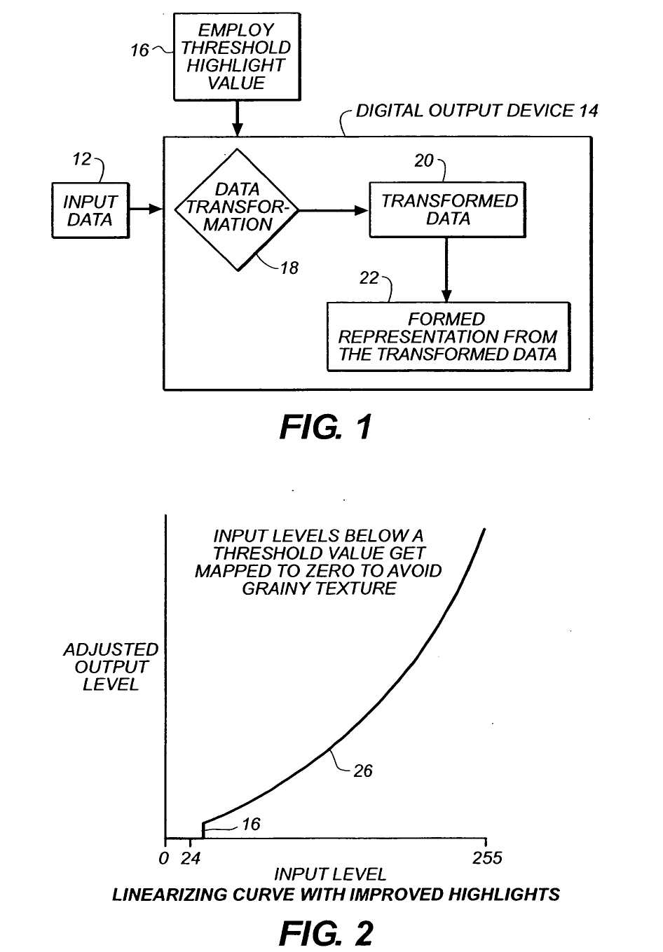

With reference to the figures, FIG. 1 is a block diagram depicting the work flow based upon the embodied methods for processing an image from data for imaging on a digital output device. The initial step in the preferred method is inputting data 12 for imaging to a digital output device 14 wherein the data for imaging comprises a plurality of image pixel values representative of the pixel intensity.

Examples of digital output devices used in the methods include ink jet printers, computer monitors, laser printers, facsimile machines, dye sublimation printers, digital offset presses, thermal printers, gravure presses, and combinations thereof. The digital output device can be an N-color printing device, wherein N is any number. Preferably, the digital output device has a spot size greater than 10 microns.

Continuing with FIG. 1, the next step in a preferred method entails employing a threshold highlight value 16 into the digital output device 14.

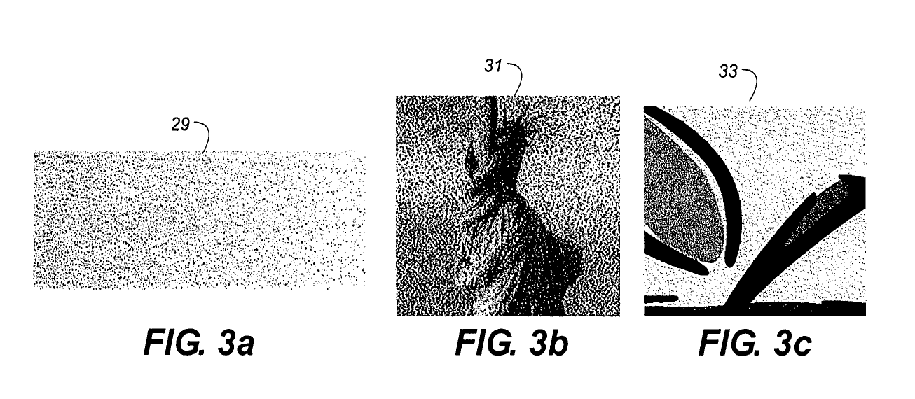

The threshold highlight value can use an algorithm 26 adapted to suppress a visual artifact that is shown in more detail in FIG. 3a, FIG. 3b and FIG. 3c. In the most preferred embodiment, the threshold highlight value is greater than zero.

FIG. 3a shows contamination of at least a homogenous color by sporadic placement of secondary colors 29. FIG. 3b shows graininess of an image 31. FIG. 3c depicts discernable individual undesirable dots in the representation 33, and combinations thereof.

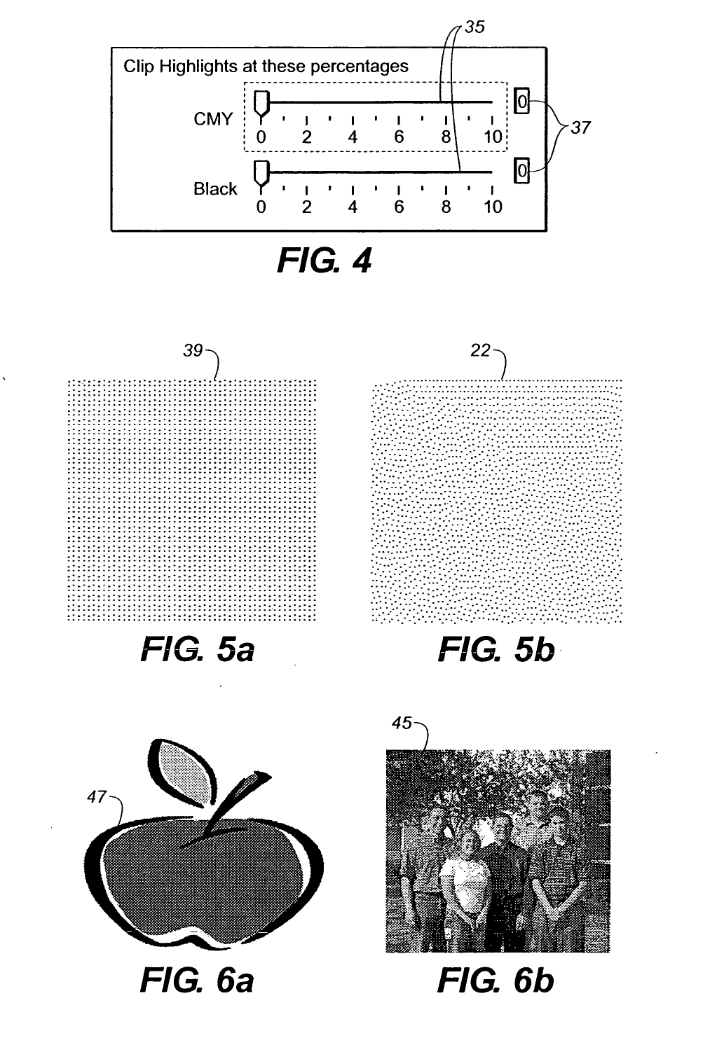

The threshold highlight value can be input by a user, such as by using a slider 35 or an edit box 37 to input the threshold highlight value. A slider 35 and en edit box 37 are depicted in FIG. 4.

The threshold highlight value is a preferably a color specific value, such as primary color in at least one embodiment of the method. The threshold highlight value includes a print speed dependent threshold value, a print media dependent threshold value and combinations thereof. The threshold highlight value is preferably greater than zero. Any value 24 below the threshold highlight value is transformed to zero.

In an alternative embodiment, the threshold highlight value is dependent on an image type from the data input to the digital output device. The image type from the data input to the digital output device can be a continuous tone image or a vector based image.

Further, the threshold highlight value can be a color space value for the data input to the digital output device. The color space value is typically CMYK, RGB, L*a*b*, XYZ, or combinations thereof. The threshold highlight value 16 can be a primary color specific value.

Primary colors are commonly modified in a color managed workflow since the color management system adds in amounts of other colors in an attempt to maintain the color fidelity of the source data. These added amounts are typically small. The resulting printed output is not the desired subtle alteration that moves primary color closer colorimetrically to the original intent. Instead, this light contamination manifests itself as a collection extra dots in an otherwise pure primary color.

A low percentage of black or darker colored ink may be included in a source image to show some slight feature. When dithered, this slight feature may manifest itself as a collection extra dots that looks more like a collection of dots than the intended feature.

Some more primitive color managed systems do not include the capability to preserve paper white. When this occurs, some small percentages of ink are included in an area that was originally intended to have no ink. When dithered, these small percentages of ink may manifest themselves as a collection of extra dots that looks more like a collection of dots than the intended paper white. Higher quality results from removing these extra percentages to restore paper white.

Returning to FIG. 1, the next step of the process involves applying data transformation to the data for imaging using the threshold highlight value to form transformed data 20. A representation can be formed from the transformed data, wherein the representation comprises a value representative of the pixel intensity greater than or equal to one. The transformation can be by dithering using one or two, or more types of dithering algorithms. For example, if a second dither is needed to enhance an image background, print quality or insertion of a vector based image, or combinations of these or other features. The dithered data or transformed data can then be printed by digital output device 14.

In FIG. 2, is an example of a one dimensional transformation of the data input employing the threshold highlight value of the methods. FIG. 2 shows input level plotted against an adjusted output level. FIG. 2 shows the threshold highlight value 16, the value below the threshold highlight value that is transformed to zero 24, and the resulting one dimensional transformation curve.

Table 1 depicts color space percentages by showing the percentage of the color if the input image, and then how threshold values change depending on the input color space.

TABLE 1

| | | | | | | | | After the Threshold | | | |
|---|---|---|---|---|---|---|---|---|---|---|---|
| | | | | | | | Threshold | Highlight Value Is | | | |
| Input RGB | | | Resulting CMYK | | | | Highlight | Applied | | | |
| R | G | B | C | M | Y | K | Value | C′ | M′ | Y′ | K′ |
| 100% | 0% | 0% | 5% | 90% | 100% | 0% | 5% | 0% | 90% | 100% | 0% |
| 0% | 100% | 0% | 80% | 0% | 99% | 3% | 5% | 80% | 0% | 99% | 0% |
| 0% | 0% | 100% | 98% | 83% | 0% | 5% | 5% | 98% | 83% | 0% | 0% |

The RGB data is transformed into CMYK color space when printed on a CMYK printing device. When performed in an ICC workflow, an interpolation is required. Sometimes, a small amount of black or another color is added to subtly alter the color to match the intended RGB color. Instead, this light contamination manifests itself as a collection extra dots in the otherwise pure color.

TABLE 2

| | | | | Threshold | | | | |
|---|---|---|---|---|---|---|---|---|
| | | | | Highlight | | | | |
| C | M | Y | K | Value | C′ | M′ | Y′ | K′ |
| 0% | 90% | 100% | 0% | 3% | 0% | 90% | 100% | 0% |
| 80% | 0% | 100% | 0% | 3% | 80% | 0% | 100% | 0% |
| 100% | 90% | 0% | 0% | 3% | 100% | 90% | 0% | 0% |

CMYK data specified by a user does not suffer such contamination because the user can explicitly control the input CMYK recipe. A smaller highlight threshold value is more appropriate in this case.

The threshold highlight value can be based on speed or paper stock. For the value based on speed, current continuous inkjet printers have image data at speeds up to 1000 fpm. Slower operation is sometimes desirable to inspect the output or clutch the printer if data is being created for the printer slower than the maximum speed of the printer. Dramatic changes in speed affect the intensity of the printed data. At the highest speeds, the printed output will appear darker than when printing at the lowest speeds. The ideal threshold highlight value differs due to this difference in change in output based on speed.

For the threshold highlight value based on paper stock, the current ink jet technology is highly dependent upon the type of paper stock used for printing. Coated paper or paper that has been treated for use with water-based ink produces higher quality and a larger color gamut. Non-coated papers are less expensive, but yield a smaller color gamut. The dot size and shape on these papers also varies, which has an effect on the ideal threshold highlight value.

Applying the data transformation 18 to the data 12 is typically performed using an ICC conversion, a linearization table, an automatic image enhancement, and combinations thereof.

ICC conversions aid in obtaining correct color reproduction when images are input from a scanner or camera, and are then displayed on a monitor or even printed. ICC conversions define the relationship between the digital counts one device receives or transmits and a standard color space defined by ICC. The relationship is based upon a measurement system defined internationally by the Commission Internationale d'Eclairage (CIE). For example, if a profile exists for a given scanner, camera, display and/or printer, the ICC conversions allow the devices to refer to a standard color space in order to combine the devices to obtain the correct color from the input device to the output device.

Linearization tables are one-dimensional input-output relationships that are used to produce linear tone on a non-linear device. The linearity of the device is measured and an inverse function is created. The inverse function is stored in the table to account for any non-linear relationships. When applied to input data, the resulting output yields a desired linear result.

Automatic image enhancements are a class of algorithms, such as sharpening, application of common upper ink limit, and automatic tone scaling. The algorithms are applied to source images prior to printing to enhance the output quality. The algorithms can be specifically tuned to maximize the quality of image data prepared for a specific output device.

The representation can be a halftone image or a binary representation. Typically, the representation has a resolution between 100 dpi and 2000 dpi, preferably a resolution of 300 dpi. Also, the representation is a value representation of the pixel intensity in the range of one to five.

FIG. 5a and FIG. 5b shows images made by the method for printing during two different dithering techniques. FIG. 5a shows one type of dither, an ordered dither 39. FIG. 5b shows another dither, an error diffusion dither or a representation 22.

FIG. 6a and FIG. 6b show the result of the data transformation on two different images, a vector based image and a continuous tone based image. respectively. The threshold highlight value is dependent on an image type from the input data for imaging to the digital output device. The input type from the data input for imaging to the digital output device is a continuous tone image 45 or a vector based image 47.

The embodiments have been described in detail with particular reference to certain preferred embodiments thereof, but it will be understood that variations and modifications can be effected within the scope of the embodiments, especially to those skilled in the art.

### PARTS LIST

12. data
14. digital output device
16. threshold highlight value
18. data transformation
20. transformed data
22. representation
24. value
26. algorithm
29. pollution of primary colors
31. graininess of an image
33. discemable individual undesirable dots in the representation
35. slider
37. edit box
39. ordered diffusion
45. continuous tone image
47. vector based image

1. A method for processing an image from data for imaging on a digital output device, wherein the method comprises:
a. inputting data for imaging to a digital output device, wherein the data for imaging comprises a plurality of image pixels values representative of the pixel intensity;
b. employing a threshold highlight value into the digital output device;
c. applying data transformation to the data for imaging using the threshold highlight value to form transformed data; and
d. forming a representation from the transformed data, wherein the representation comprises a value representative of the pixel intensity greater than or equal to 1.

2. The method of claim 1, wherein the digital output device comprises a spot size greater than 10 microns.

3. The method of claim 1, wherein the digital output device is an ink jet printer, a computer monitor, a laser printer, digital off set presses, thermal printers, a facsimile machine, or combinations thereof.

4. The method of claim 1, wherein the digital output device is an N-color printing device, wherein N is any number.

5. The method of claim 1, wherein the step of employing the threshold highlight value comprises using an algorithm adapted to suppress a visual artifact.

6. The method of claim 5, wherein the algorithm is a look up table.

7. The method of claim 5, wherein the visual artifact comprises a member of the group consisting of contamination of at least a homogeneous color by sporadic placement of secondary colors, graininess of an image, discernable individual undesirable dots, and combinations thereof.

8. The method of claim 1, wherein the threshold highlight value is greater than zero.

9. The method of claim 1, wherein transformed data below the threshold highlight value are transformed to zero prior to forming the representation from the transformed data.

10. The method of claim 1, wherein the threshold highlight value is employed by inputting the threshold highlight value to the digital output device with an edit box.

11. The method of claim 1, wherein the threshold highlight value is a color specific value.

12. The method of claim 1 1, wherein the color specific value is a primary color.

13. The method of claim 1, wherein the threshold highlight value comprises a print speed dependent threshold value, a print media dependent threshold value, and combinations thereof.

14. The method of claim 1, wherein the threshold highlight value is dependent on an image type from the input data for imaging to the digital output device.

15. The method of claim 14, wherein the image type from the data input for imaging to the digital output device is a continuous tone image.

16. The method of claim 14, wherein the image type from the data input for imaging to the digital output device is a vector based image.

17. The method of claim 1, wherein the threshold highlight value is an output device colorant value for the input data to the digital output device, wherein the output device colorant value is selected from the group consisting of CMYK, RGB, L*a*b*, XYZ, and other equivalent color spaces, and combinations thereof.

18. The method of claim 1, further comprising the step of using a slider to input the threshold highlight value.

19. The method of claim 1, wherein the step of applying data transformation to the data for imaging uses a member of the group comprising: an ICC conversion, a linearization table, an automatic image enhancement, and combinations thereof.

20. The method of claim 1, wherein the step of applying the data transformation to the data for imaging comprises applying a three dimensional data transformation.

21. The method of claim 1, wherein the step of applying the data transformation to the data for imaging comprises applying at least four dimensional data transformation.

22. The method of claim 1, wherein the step of applying data transformation is applied pixel by pixel.

23. The method of claim 1, wherein the step of applying data transformation is applied vector by vector.

24. The method of claim 1, wherein the step of forming of the representation from the transformed data is by dithering.

25. The method of claim 1, wherein the representation is a halftone image.

26. The method of claim 1, wherein the representation is a binary representation.

27. The method of claim 1, wherein the representation comprises a resolution between 100 dpi and 2000 dpi.

28. The method of claim 1, wherein the representation comprises a value representative of the pixel intensity in the range of one and five.

29. The method of claim 1, further comprising the step of changing the threshold highlight value based on an additional dither.

30. The method of claim 29, wherein the second dither is adapted to enhance a desired customer feature selected from the group comprising: enhancement of an image background, insertion of a vector based image, and combinations thereof.
